(19) United States
(12) Patent Application Publication
(10) Pub. No.: US 2026/0001294 A1
(43) Pub. Date: Jan. 1, 2026

(54) PLANT MATERIAL COMPACTION APPARATUS

(71) Applicant: Howard Stoller, Glen Ellyn, IL (US)

(72) Inventor: Howard Stoller, Glen Ellyn, IL (US)

(21) Appl. No.: 18/756,578

(22) Filed: Jun. 27, 2024

(51) Int. Cl. B30B 15/06

(52) U.S. Cl. CPC B30B 15/062

(57) ABSTRACT

An apparatus for compacting plant material is described. The apparatus for compacting plant material includes a press plate to contact plant material and a handle to enable operation by a user. The press plate may include one or more air channels to allow air flow through the press plate. The press plate is configured to occupy a full cross-section of a plant material container. The handle may be removable from the press plate or integrated with the press plate, wherein the handle is oriented parallel to the press plate. The press plate may have a surface profile on at least one face to increase efficiency for a particular task. The press plate may be reversible. The press plate may include a weight plate. The press plate and the handle may each include a coating. The coating may reduce slippage. The coating may increase operational life.

### TECHNICAL FIELD

This disclosure relates generally to an apparatus for the compaction of plant material, and more particularly to an apparatus including an air channel press plate with a handle for compacting plant material to fit into a plant material container.

### BACKGROUND

The task of efficiently compacting plant material, such as leaves, grass clippings, twigs, and other lawn care debris, presents a significant challenge for both homeowners and professional landscapers. Traditional methods of manually compacting this plant material often prove cumbersome and ineffective, leading to uneven distribution and suboptimal use of collection bag space. This difficulty is compounded when dealing with large volumes of material, which can quickly overwhelm standard-sized collection bags, necessitating frequent bag changes and increasing the overall time and effort required for lawn and garden maintenance. Consequently, there is a clear need for an apparatus that can streamline this process.

While there are various methods available for compacting plant material, many of these alternatives come with significant drawbacks. For example, using one's hands for feet to manually compress leaves and clippings can be time-consuming and ineffective, often resulting in inefficient compression. Mechanical devices like leaf blowers or vacuums with mulching capabilities can help reduce the volume of plant material, but do not address the need for effective compression within collection bags. The absence of a correctly sized or shaped press plate exacerbates these challenges, as it hinders the ability to achieve uniform compression.

### SUMMARY

The following presents a simplified summary of various aspects of this disclosure in order to provide a basic understanding of such aspects. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the present disclosure, an apparatus for compacting plant material is provided. A press plate to contact and compress plant material may be affixed to a handle for operation by a user. The press plate may include an air channel to allow air to pass through the press plate for efficient movement while inside a plant material container. The handle may be removed from the press plate for cleaning, replacement, or storage. In another implementation, the handle may be an integrated handle that may be molded onto or otherwise permanently affixed to the press plate. The handle may be oriented parallel to the press plate.

In another aspect of the present disclosure, the press plate may include multiple air channels to increase and optimize the available cross-section for air flow through the press plate.

In another aspect of the present disclosure, the press plate may be constructed from a rigid material such as wood, plastic, metal, bonded paper, or recycled plant material, or a combination thereof.

In another aspect of the present disclosure, the press plate includes a weighted plate, which may be integral to the press plate or may be removed and replaced, to increase the downward force of the press plate when in operation.

In another aspect of the present disclosure, the press plate may include an edge with a shape or orientation designed to tuck plant material into a plant material container more efficiently or neatly.

In another aspect of the present disclosure, the press plate may include a coating on an exterior surface. The coating may be a sealant or a plastic or another coating designed to protect and extend the operational life of the press plate.

In another aspect of the present disclosure, the handle may be constructed from a rigid material such as wood, plastic, metal, bonded paper, or recycled plant material, or a combination thereof. The handle and the press plate may be constructed from the same material or different materials.

In another aspect of the present disclosure, the handle may include a coating on an exterior surface. The coating may be a natural rubber or a synthetic rubber or another coating designed to reduce slippage during use. The handle and the press plate may have the same coating or different coatings.

In another aspect of the present disclosure, the press plate may include a surface with an uneven profile. The surface profile may be designed to increase compression in a particular pattern. The press plate may have a surface profile on one face that is different from the surface profile on the other face. The press plate may be designed to be removed and rotated to utilize a preferred surface profile.

### BRIEF DESCRIPTION OF THE DRAWINGS

The present disclosure is illustrated by way of example, and not by way of limitation, in the figures of the accompanying drawings, in which:

FIG. 1 illustratively depicts a top front right side isometric view of an apparatus for compacting plant material, in accordance with an implementation of the disclosure;

FIG. 2 illustratively depicts bottom rear left side isometric view of an apparatus for compacting plant material, in accordance with an implementation of the disclosure;

FIG. 3 illustratively depicts a left side elevation view of an apparatus for compacting plant material, in accordance with an implementation of the disclosure;

FIG. 4 illustratively depicts a front elevation view of an apparatus for compacting plant material, in accordance with an implementation of the disclosure;

FIG. 5 illustratively depicts a top plan view of an apparatus for compacting plant material, in accordance with an implementation of the disclosure;

FIG. 6 illustratively depicts a bottom plan view of an apparatus for compacting plant material, in accordance with an implementation of the disclosure; and

FIG. 7 illustratively depicts a perspective in use view of an apparatus for compacting plant material, in accordance with an implementation of the disclosure.

### DETAILED DESCRIPTION

Before the present subject matter is described in detail, it is to be understood that this disclosure is not limited to the particular implementations described, as such may vary. It should also be understood that the terminology used herein is to describing particular implementations only, and is not intended to be limiting, since the scope of the present disclosure will be limited only by the appended claims. While this disclosure is susceptible to different implementations in different forms, there is shown in the drawings and will here be described in detail a preferred implementation of the disclosure with the understanding that the present disclosure is to be considered as an exemplification of the principles of the disclosure and is not intended to limit the broad aspect of the disclosure to the implementation illustrated. All features, elements, components, functions, and steps described with respect to any implementation provided herein are intended to be freely combinable and substitutable with those from any other implementation unless otherwise stated. Therefore, it should be understood that what is illustrated is set forth only for the purposes of example and should not be taken as a limitation on the scope of the present disclosure.

In the following description and in the figures, like elements are identified with like reference numerals. The use of “e.g.,” “etc.,”, “or” and “the like” indicates non-exclusive alternatives without limitation, unless otherwise noted. The use of “having”, “comprising”, “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one implementation, to A only (optionally including entities other than B); in another implementation, to B only (optionally including entities other than A); in yet another implementation, to both A and B (optionally including other entities). These entities may refer to elements, actions, structures, steps, operations, values, and the like.

As used herein, “plant material” means any organic matter derived from plants, encompassing a wide range of components and by-products including at least leaves, grass clippings, twigs and small branches, weeds, flowers and petals, seeds and seeds pods, stems and stalks, roots and root fragments, bark and wood chips, fruits and vegetables, and plant debris. Plant material may also include non-organic debris such as yard trash, plastic, paper, or other debris that may find its way into a plant material container.

Maintaining a tidy and well-manicured lawn involves not only regular mowing and trimming but also the efficient collection and disposal of plant material. One of the primary challenges faced by both homeowners and professional landscapers is the difficulty of compacting this plant material neatly within collection bags. Traditional methods of manually compressing lawn debris often result in uneven distribution and suboptimal use of bag space, which can be particularly problematic when dealing with large volumes of plant material. This inefficiency necessitates frequent bag changes, increasing the time and effort required for lawn maintenance. For homeowners, this means spending more time on yard work and less time enjoying their outdoor spaces. For landscapers, the additional labor and materials translate into higher operational costs and reduced productivity.

Various methods have been employed to address the issue of compacting plant material, but each comes with its own set of limitations. Manual compaction using hands or feet is a common approach, but it is labor-intensive and often ineffective, leading to unevenly packed bags that cannot hold as much material as possible. Further, direct contact with some plant material may cause injury due to thorns, sharp edges, or poisonous plants. Mechanical devices such as leaf blowers or vacuums equipped with mulching capabilities offer a way to reduce the volume of plant debris; however, they do not solve the problem of achieving efficient compaction within collection bags. These devices can also be expensive, require regular maintenance, may not be environmentally friendly, and may not always be accessible to the average homeowner.

The absence of a correctly sized or shaped press plate further complicates the compaction process. Without a tool specifically designed to fit the dimensions of a collection bag, a user may find it challenging to achieve uniform compaction. This can result in wasted space within the bags, leading to an increased number of bags needed to handle the same volume of plant material. More bags mean higher costs and a greater environmental impact due to the additional bag waste. Moreover, improper compression can cause the bags to become unbalanced, difficult to handle, or prone to tearing, which adds another layer of inconvenience and inefficiency to the task of lawn care.

The present disclosure addresses these challenges by introducing a handle and a press plate designed to fit the cross-section of a specific plant collection bag. This innovative tool allows a user to achieve a higher degree of compaction, maximizing the mass of plant material that each bag can hold. By ensuring that the press plate matches the bag's dimensions, the present disclosure facilitates uniform compaction, making the most efficient use of the available volume. This reduces the frequency of bag changes, saving time and effort for homeowners and professional landscapers alike. Additionally, fewer bags are required overall, leading to cost savings and a reduced environmental impact.

The use of the term “user” can equally be applied to any user in any profession or industry that wishes to compact plant material.

Various aspects of the above referenced apparatus are described in detail herein below by way of examples, rather than by way of limitation.

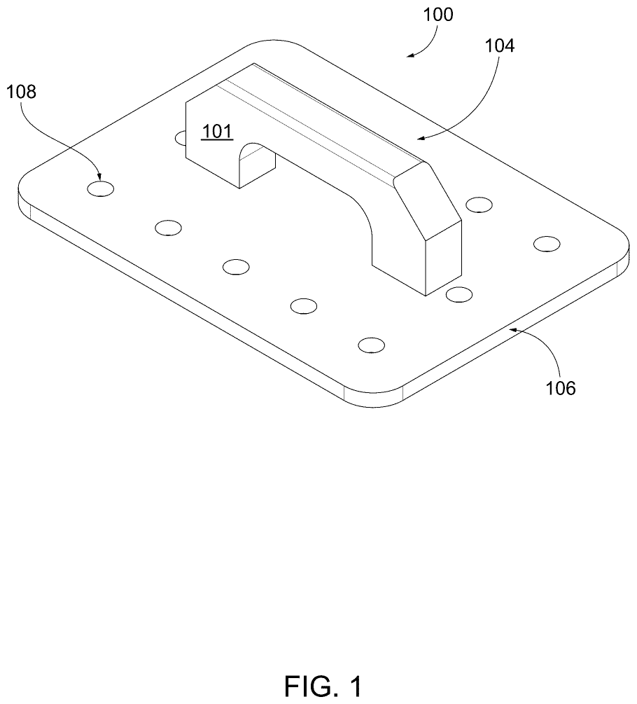

FIG. 1 illustratively depicts a top front right side isometric view of an exemplary apparatus for compacting plant material 100. The apparatus for compacting plant material 100 includes a handle 101 and a press plate 104. The press plate 104 includes an edge 106 and an air channel 108. The handle 101 and the press plate 104 may be constructed of the same material or different materials.

The press plate 104 is a substantially planar, rigid component designed to facilitate the compaction of plant material within a plant material container (not depicted). In an implementation, the press plate 104 includes at least one air channel 108 to allow air to pass through the press plate 104 while compacting plant material in a plant material container (not depicted). By allowing the movement of air through the press plate 104, the press plate 104 may occupy a greater portion of the cross-section of the plant material container (not depicted). In an implementation, the press plate 104 is designed with a shape and dimensions to occupy the full cross-section of a plant material container (not depicted). The press plate 104 may be designed to occupy the full cross-section of another plant material container (not depicted). The press plate 104 may be constructed from a rigid material such as wood, plastic, metal, bonded paper, recycled plant material, or another rigid material, or a combination thereof.

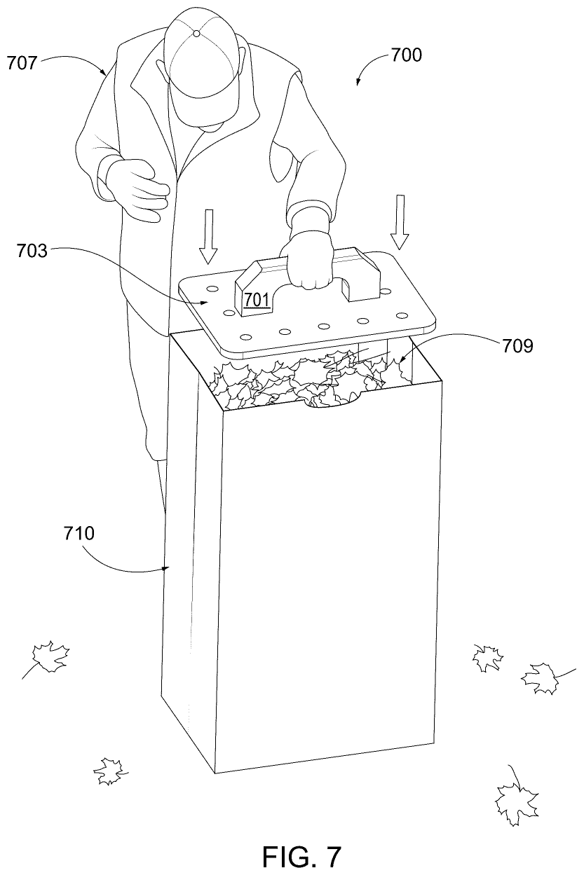

In FIG. 1, a handle 101 is shown affixed to the press plate 104 to contact plant material. In an implementation, the handle 101 is oriented parallel to the press plate 104 along a major axis. In another implementation, the handle 101 is oriented parallel to the press plate 104 along a minor axis. In another implementation, the handle 101 is oriented normal to the press plate 104. The handle 101 may be permanently or removably affixed to the press plate 104 by screws, bolts and nuts, rivets, adhesive bonding, threaded inserts, clamping mechanisms, or by another means. In one implementation, the handle 101 is affixed to one or more handle mount points (not depicted) using screws. In one implementation, the handle 101 is designed to be removed and replaced for cleaning, replacement, storage, or to expose another surface profile of the press plate 104. In yet another implementation, the handle 101 is designed to be integrated with the press plate 104 and is thus permanently affixed or otherwise a part of the press plate 104 and is not removable. The handle 101 may be constructed from a rigid material such as wood, plastic, metal, bonded paper, recycled plant material, or another rigid material, or a combination thereof. Although the handle 101 is depicted to be used by a user compacting plant material by pushing in a downward direction (as depicted in FIG. 7), in other implementations, the handle may be affixable to a rod (e.g., a rod of yard rake) or another instrument.

A user may wish to use the apparatus for compacting plant material 100 to compress plant material in order to better fit more of the material into a bag for yard waste disposal than other traditional methods of placing leaves into the bag (e.g., by using hands or a yard rake to push leaves into the bag). The user may be able to compress significantly more plant material into a bag than traditional methods in a manner described herein with respect to FIG. 7.

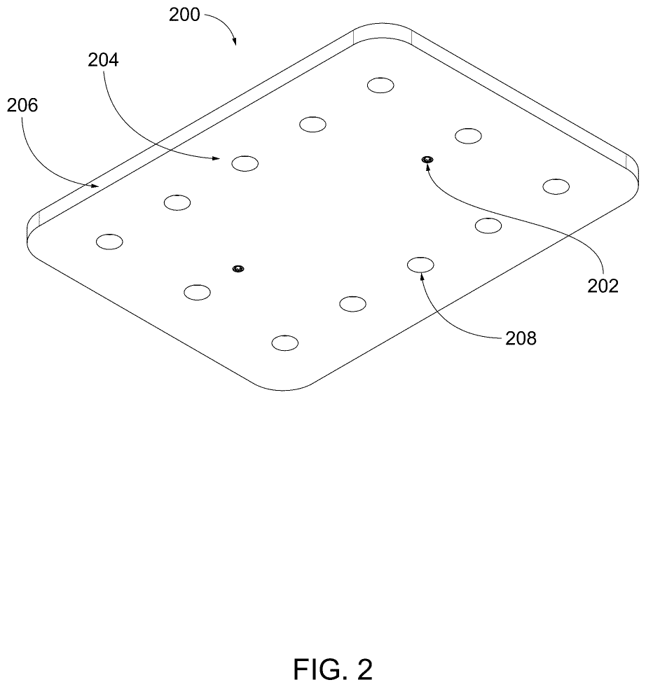

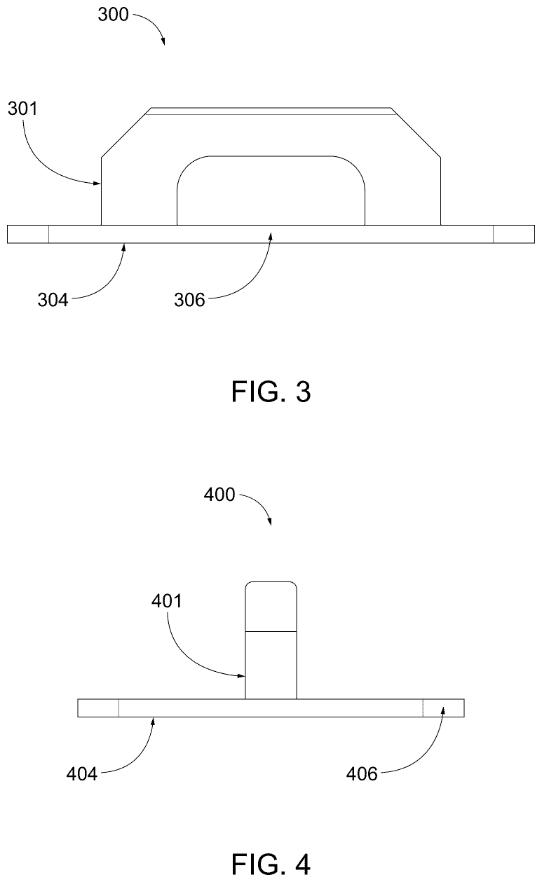

Further details regarding the air channel 108 and the edge 106 are provided herein with respect to FIG. 2 and FIG. 3, respectively.

FIG. 2 illustratively depicts a bottom rear left side isometric view of an exemplary apparatus for compacting plant material 200. The apparatus for compacting plant material 200 may be the same as the apparatus for compacting plant material 100 as described above. The apparatus for compacting plant material 200 includes a press plate 204. The press plate 204 includes a handle mount point 202, an edge 206, and an air channel 208.

As previously discussed above, the press plate 204 includes an air channel 208. The air channel 208 is designed to facilitate the efficient occupation of the full cross-sectional area of a plant material container (not depicted) by enabling the escape of trapped air, thereby preventing the formation of air pockets and ensuring even compaction of the plant material. In an implementation, the air channel 208 is a cylindrical or conical aperture, sized appropriately to balance airflow and structural integrity. In an implementation, the press plate 204 includes multiple air channels 208. The multiple air channels 208 may be distributed across the surface of the press plate 204 in a pattern that ensures maximum coverage and efficiency. The multiple air channel 208 may be arranged in any pattern and may be apertures that extend fully through or partially through the press plate 204. One air channel 208 or multiple air channels 208 may be included.

The handle mount point 202 provides a secure and stable attachment between the press plate 204 and the handle (not viewable in FIG. 2). The handle mount point 202 may be used to remove and replace the handle for cleaning, replacement, storage, or rotation of the press plate 204 relative to the handle. In an implementation, the handle mount point 202 consists of pre-drilled holes (not depicted) aligned with holes (not depicted) in the handle to allow the use of screws to permanently or removably affix the handle to the press plate 204. The handle mount point 202 may be configured to accommodate screws, bolts, or other fasteners. The pre-drilled holes (not depicted) may be reinforced to withstand repeated use and the mechanical stresses associated with the compaction of plant material. In an implementation, the pre-drilled holes (not depicted) are reinforced using at least one of metal inserts, threaded inserts, reinforcement rings, bonded bushings, laminated reinforcement, epoxy fillers, or integrated ribbing.

Further details regarding the edge 206 are provided with respect to FIG. 3 described herein.

FIG. 3 illustratively depicts a left side elevation view of an exemplary apparatus for compacting plant material 300. The apparatus for compacting plant material 300 may be the same as the apparatus for compacting plant material 100 or the apparatus for compacting plant material 200 as described above. The apparatus for compacting plant material 300 includes a handle 301 and a press plate 304. The press plate 304 includes an edge 306.

As previously discussed with respect to FIG. 1 described above, a handle 301 may be permanently or removably affixed to the press plate 304. The design of the handle 301 may permit a user (not depicted) to hold and operate the apparatus for compacting plant material 300. As depicted in FIG. 3, the handle 301 may be oriented parallel to the press plate 304 along a major axis thereof. Alternatively, the handle 301 may be oriented parallel to the press plate 304 along a minor axis thereof, or the handle 301 may be oriented normal to a face of the press plate 304. In an implementation, the handle 301 is a straight handle. Alternatively, the handle 301 may be a T-handle or a D-handle. In an implementation, the handle 301 is a telescopic handle that offers an adjustable length to enable the apparatus for compacting plant material 300 to be used in additional contexts. In another implementation, the handle 301 is ergonomically contoured to fit the natural shape of a hand of a user. Other types of handles may be used.

FIG. 3 further depicts an edge 306 along the perimeter of the press plate 304. The press plate 304 may include multiple edges 306 to more efficiently occupy the full cross-section of a specific plant material container (not depicted). In an implementation, the edge 306 is designed to facilitate a tucking motion that enhances the compaction of the plant material (not depicted) within the plant material container (not depicted). In an implementation, the edge 306 is beveled or chamfered to more easily slide under and push plant material into the corners and sides of the plant material container. In an implementation, the edge 306 is smooth or rounded to prevent damage to the plant material container during the tucking and compaction process when a user operates the apparatus for compacting plant material 300. The edge 306 may be reinforced to withstand the forces applied during compaction with repeated use. In an implementation, the edge 306 includes a flexible material to adapt to slight variations in the shape and size of the plant material container.

FIG. 4 illustratively depicts front elevation view of an exemplary apparatus for compacting plant material 400. The apparatus for compacting plant material 400 may be the same as the apparatus for compacting plant material 100, the apparatus for compacting plant material 200, or the apparatus for compacting plant material 300 as described above. The apparatus for compacting plant material 400 includes a handle 401 and a press plate 404. The press plate 404 includes an edge 406.

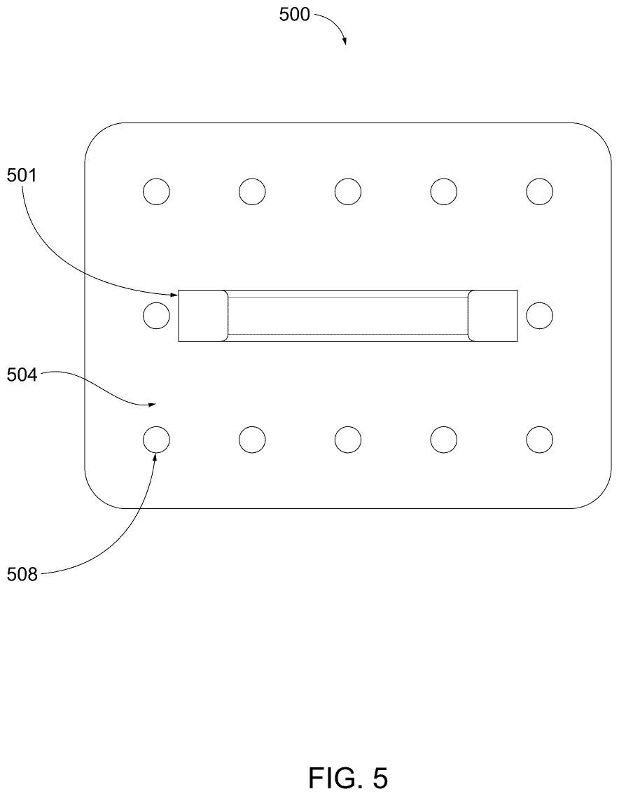

Details regarding the handle 401 are provided with respect to FIGS. 1, 2, and 3 described above. Details regarding the press plate 404 are provided with respect to FIGS. 1 and 2 described above and FIG. 5 described herein below. Additional details regarding the edge 406 are with respect to FIG. 3 described above.

Referring now to FIG. 4, the handle 401 may include a coating. A coating may be applied to the handle 401 to reduce slippage during use. The handle 401 may include one or more coatings or one or more layers of a coating. In an implementation, a coating is applied to the handle 401 to protect the handle 401 and to protect and extend the operational life of the handle 401. In an implementation, a coating is applied to the handle 401 to improve ease of cleaning or for aesthetic appeal. The selection of coating for the handle 401 may depend upon the selection of material for the handle 401 as discussed with respect to FIG. 1 described above. In an implementation, the coating is one or more of rubber, synthetic rubber, silicone, epoxy, foam, paint, polyurethane, polyvinyl chloride (PVC), or another material, or a combination thereof.

As will be discussed with respect to FIG. 5 described herein, a coating may also be applied to the press plate 404. The coating may be an optional feature.

FIG. 5 illustratively depicts a top plan view of an apparatus for compacting plant material 500. The apparatus for compacting plant material 500 may be the same as the apparatus for compacting plant material 100, the apparatus for compacting plant material 200, the apparatus for compacting plant material 300, or the apparatus for compacting plant material 400 as described above. The apparatus for compacting plant material 500 includes a handle 501 and a press plate 504. The press plate 504 includes an air channel 508.

Details regarding the handle 501 are provided with respect to FIGS. 1, 2, 3, and 4 described above. Details regarding the press plate 504 are provided with respect to FIGS. 1 and 2 described above. Details regarding the air channel 508 are provided with respect to FIG. 2 described above.

Referring now to FIG. 5, the press plate 504 may include a coating. A coating may be applied to the press plate 504 to reduce slippage during use. The press plate 504 may include one or more coatings or one or more layers of a coating. In an implementation, a coating is applied to the press plate 504 to protect the press plate 504 and to protect and extend the operational life of the press plate 504. In an implementation, a coating is applied to the press plate 504 to improve ease of cleaning or for aesthetic appeal. The selection of coating for the press plate 504 may depend upon the selection of material for the press plate 504 as discussed with respect to FIG. 1 described above. In an implementation, the coating is one or more of rubber, synthetic rubber, silicone, epoxy, foam, paint, polyurethane, polyvinyl chloride (PVC), or another material.

The press plate 504 may include a weighted plate (not depicted) to increase the weight of the press plate 504. Incorporating a weighted plate (not depicted) increases the downward force applied to the plant material, facilitating more effective compaction with less effort from a user. This enhanced compaction force ensures that plant material is compacted more densely, optimizing the capacity of the plant material container (not depicted). Additionally, a weighted plate (not depicted) may improve stability and control during the compaction process, reducing the likelihood of shifting or wobbling and promoting even distribution within the plant material container (not depicted). In an implementation, the weighted plate (not depicted) has a weight between 5 pounds and 10 pounds. In another implementation, the weighted plate (not depicted) has a weight of less than 5 pounds. The weighted plate (not depicted) may be constructed from one or more of a dense material such as steel, iron, aluminum, high-density polyethylene (HDPE), reinforced plastic, composite materials, brass, concrete, or another metal, or a combination thereof. The weighted plate (not depicted) may be permanently or removably affixed to a surface of the press plate 504 using any appropriate means such as screws, bolts and nuts, rivets, welding, adhesive bonding, threaded inserts, clamping mechanisms, bonded bushings, epoxy fillers, or another means. In an implementation, the weighted plate (not depicted) is integral to the press plate 504. In another implementation, the weighted plate is an optional feature and may not be integral to the press plate 504 or may not be included.

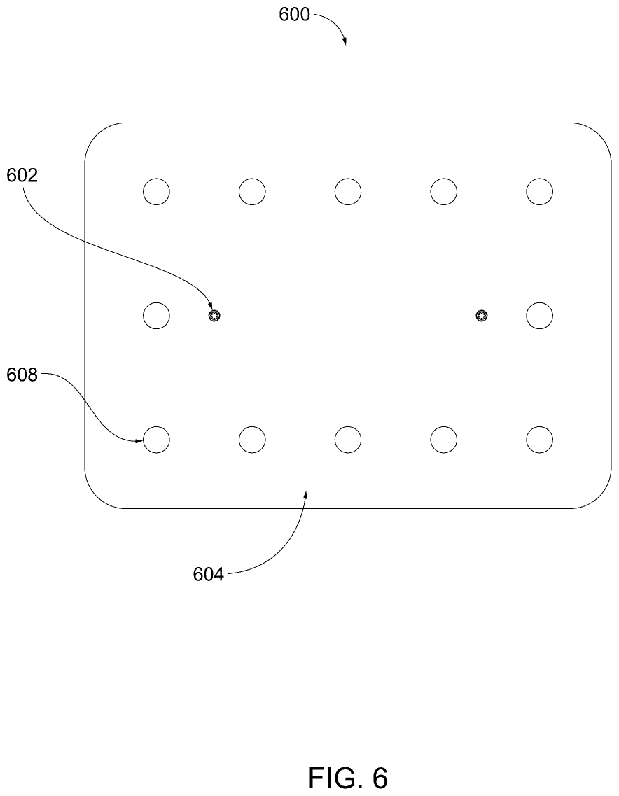

FIG. 6 illustratively depicts a bottom plan view of an apparatus for compacting plant material 600. The apparatus for compacting plant material 600 may be the same as the apparatus for compacting plant material 100, the apparatus for compacting plant material 200, the apparatus for compacting plant material 300, the apparatus for compacting plant material 400, or the apparatus for compacting plant material 500 as described above. The apparatus for compacting plant material 600 includes a press plate 604. The press plate 604 includes a handle mount point 602, and an air channel 608.

Details regarding the press plate 604 are provided with respect to FIGS. 1, 2, and 5 described above. Details regarding the handle mount point 602 are provided with respect to FIG. 2 described above. Details regarding the air channel 608 are provided with respect to FIG. 2 described above.

As depicted in FIG. 6, the exposed surface profile of the press plate 604 is substantially flat. Alternatively, the press plate 604 may be reversible, including a first surface profile (not depicted) and a second surface profile (not depicted). By removing the handle (not depicted) at the handle mount point 602 and permanently or removably affixing the handle (not depicted) in a different position, a user may expose either the first surface profile (not depicted) or the second surface profile (not depicted) of the press plate 604 for use in compaction of plant material. A reversible press plate 604 with a first surface profile (not depicted) and a second surface profile (not depicted) may provide significant advantages in terms of versatility, efficiency, and adaptability. In an implementation, the first surface profile (not depicted) of the press plate 604 includes a smooth, flat surface for general compaction and the second surface profile (not depicted) of the press plate 604 includes a textured or grooved surface for handling challenging materials such as wet leaves or sticky plant debris.

FIG. 7 illustratively depicts a perspective view of an apparatus for compacting plant material in use 700. The perspective view of an apparatus for compacting plant material in use 700 includes an apparatus for compacting plant material 703, a user 707, and a plant material container 710. The apparatus for compacting plant material 703 may be the same as the apparatus for compacting plant material 100, the apparatus for compacting plant material 200, the apparatus for compacting plant material 300, the apparatus for compacting plant material 400, the apparatus for compacting plant material 500, or the apparatus for compacting plant material 600 as described above. The plant material container 710 includes plant material 709.

The plant material container 710 serves as the receptacle for collecting, compacting, and storing plant material 709 until disposal. The design and characteristics of the plant material container 710 may influence the efficiency of the compaction process as well as the shape and dimensions of the apparatus for compacting plant material 703. In an implementation, the plant material container 710 is a rigid and reusable container constructed from a durable material such as plastic, wood, metal, composites, concrete, or another material, or a combination thereof. In another implementation, the plant material container 710 is a disposable container constructed from a flexible material such as polypropylene, canvas, nylon, biodegradable plastic, paper, or another material, or a combination thereof.

The plant material container 710 may be selected based on the plant material 709 to be collected and compacted. Plant material 709 encompasses a wide range of organic debris generated from gardening, lawn maintenance, and landscaping activities. In an implementation, the plant material 709 includes plant debris such as one or more of leaves, grass clippings, twigs, and other lawn care waste. In another implementation, the plant material 709 also includes one or more of roots, root fragments, bark, wood chips, fruits, vegetables, soil, small rocks, and incidental non-organic debris. The plant material 709 may include moisture. The heterogeneous nature of the plant material 709 necessitates versatile and robust tools for effective compaction and disposal.

Referring now to FIG. 7, a user 707 may operate the apparatus for compacting plant material 703 to compact plant material 709 in a plant material container 710. First, the user 707 places a layer of plant material 709 to be compacted into the plant material container 710. Then, the user 707 places the apparatus for compacting plant material 703 over the plant material 709 and applies a downward force in a downward direction as depicted by the arrows. The user may use one hand to push down on the handle 701, while holding the plant material container 710 with the other hand. In another implementation, the user may use both hands to push down on the handle 701. In yet another implementation, the user may use one hand to push down on the handle 701 while the other hand is free to perform another function or rest. The combined downward force and the weight of the apparatus for compacting plant material 703 ensures thorough compaction, significantly reducing the volume of the plant material 709. Another layer of plant material 709 may be placed over the first, compacted layer of plant material 709. In an implementation, the apparatus for compacting plant material 703 is designed to facilitate a tucking motion for a more even distribution and compaction than manually pressing the plant material 703 into a bag. In an implementation, the efficient design of the apparatus for compacting plant material 703 enables at least three times more plant material 709 to be loaded into a plant material container 710. This enhanced capacity reduces the frequency of bag changes, saving time and effort, and supports sustainable practices and cost efficiency by optimizing the use of plant material containers 710.

In one example, suppose that a user wishes to compress plant material into the plant material container 710 (e.g., a leaf bag). The leaf bag may measure 34″ in height. When the bag is filled with plant material to the top of the bag, the user may compress the plant material by applying a force by pushing down on the handle 701 of the apparatus for compacting plant material 703. Suppose that the user was able to apply a 20-pound force onto the apparatus by pushing down onto the apparatus with the user's hand/hands. The user may compress the plant material that previously was filled to the top of the bag down to 13″. Using additional force and pushing the apparatus for compacting plant material 703 further in a downward direction, the user may further compress the leaves down to 10″. In one example, the user may use the apparatus for compacting plant material 703 to push down plant material so that the bag can accommodate 3 times the plant material versus the uncompressed form of the plant material placed that is placed into the bag. In other examples, the user may be able to compress 1.5, twice, or more plant material into a bag than using traditional methods.

Features depicted in one figure may applied to other figures that may not depict such features.

While the implementations are susceptible to various modifications and alternative forms, specific examples thereof have been shown in the drawings and are herein described in detail. It should be understood, however, that these implementations are not to be limited to the particular form disclosed, but to the contrary, these implementations are to cover all modifications, equivalents, and alternatives falling within the spirit of the disclosure. Furthermore, any features, functions, steps, or elements of the implementations may be recited in or added to the claims, as well as negative limitations that define the inventive scope of the claims by features, functions, steps, or elements that are not within that scope.

What is claimed is:

1. An apparatus for compacting plant material, the apparatus comprising:
a press plate to contact plant material;
wherein the press plate comprises an air channel configured to allow air to pass through the press plate,
wherein the press plate is configured to occupy a full cross-section of a plant material container; and
a handle one of removably or permanently affixed to the press plate,
wherein the handle is oriented parallel to the press plate.

2. The apparatus of claim 1, wherein the press plate comprises a plurality of air channels.

3. The apparatus of claim 1, wherein the press plate comprises at least one of wood, plastic, metal, bonded paper, and recycled plant material.

4. The apparatus of claim 1, wherein the press plate comprises a weighted plate.

5. The apparatus of claim 1, wherein the press plate comprises an edge configured to facilitate a tucking motion that enhances the compaction of the plant material.

6. The apparatus of claim 1, wherein the press plate comprises a coating.

7. The apparatus of claim 6, wherein the coating is configured to protect the press plate.

8. The apparatus of claim 1, wherein the handle comprises at least one of wood, plastic, metal, bonded paper, and recycled plant material.

9. The apparatus of claim 1, wherein the handle comprises a coating.

10. The apparatus of claim 9, wherein the coating is configured to reduce slippage during use.

11. The apparatus of claim 1, wherein the handle is configured to be one of: removable and replaceable, and permanently affixable to the press plate.

12. The apparatus of claim 11, wherein the press plate comprises a first surface profile and a second surface profile, and wherein the handle may be removed and removably affixed to the press plate to expose one of the first surface profile or the second surface profile.
